(19) United States
(12) Patent Application Publication
(10) Pub. No.: US 2013/0186377 A1
(43) Pub. Date: Jul. 25, 2013

(54) ENGINE WITH COOLANT THROTTLE AND METHOD FOR CONTROLLING THE SAME

(71) Applicants: Steven M. Ryan, Villa Park, IL (US); Steven J. Dickerson, Lake in the Hilles, IL (US)

(72) Inventors: Steven M. Ryan, Villa Park, IL (US); Steven J. Dickerson, Lake in the Hilles, IL (US)

(21) Appl. No.: 13/702,065

(22) PCT Filed: Jun. 4, 2010
(86) PCT No.: PCT/US2010/037360

§ 371 Date: Mar. 18, 2013

(51) Int. Cl. F02M 25/07

(52) U.S. Cl. CPC F02M 25/0726
USPC 123/568.12

(57) ABSTRACT

A method of controlling cooling flow through a coolant system of an internal combustion engine having an electronic control module, a cooling throttle, an EGR cooler, and an interstage cooler is provided. A pressure within a coolant system is determined. A temperature within the coolant system is determined. A temperature of exhaust gas exiting an EGR cooler is determined. A temperature of intake air exiting an interstage cooler is determined. A position of a cooling throttle within the coolant system is adjusted based upon at least one of the determined pressure within the coolant system, temperature within the coolant system, temperature of exhaust gas exiting the EGR cooler, and temperature of intake air exiting an interstage cooler being above respective predefined thresholds to adjust fluid flow within the coolant system.

### TECHNICAL FIELD

The present disclosure relates to an engine having a coolant throttle, and more particularly to an engine having a coolant throttle that is utilized to control pressure within a cooling system to prevent damage to a radiator.

### BACKGROUND

Engine coolant may be utilized to control the temperature of a variety of engine components including portions of an engine block, portions of a cylinder head, an exhaust gas recirculation (EGR) cooler, and an interstage cooler located between two compressors of the air intake system. Several of these components, such as the EGR cooler and the interstage cooler, transfer a large amount of heat into the cooling system, requiring vehicles to have higher cooling flow rates, in order to maintain appropriate operating temperatures. However, these higher cooling flow rates are only needed during certain operating conditions. Therefore, a need exists for a cooling system with a coolant throttle to control the flow rate, and therefore the pressure, within a cooling system.

### SUMMARY

According to one embodiment, an engine cooling system for an internal combustion engine comprises an electronic control module, a cooling throttle, a pressure sensor, a first temperature sensor, and a second temperature sensor. The cooling throttle is positionable between an open position and a closed position. The cooling throttle is disposed in fluid communication with the cooling system. The cooling throttle controls a flow rate of coolant within the cooling system. The cooling throttle is disposed in communication with the electronic control module. The pressure sensor is disposed in fluid communication with the cooling system. The pressure sensor is disposed in communication with the electronic control module. The pressure sensor generates an output to the electronic control module. The first temperature sensor is disposed in fluid communication with the cooling system. The first temperature sensor is disposed in communication with the electronic control module. The first temperature sensor generates an output to the electronic control module. The second temperature sensor is disposed in fluid communication with exhaust gas downstream of an EGR cooler. The second temperature sensor is disposed in communication with the electronic control module. The second temperature sensor generates an output to the electronic control module. Wherein the electronic control module generates an output to adjust the position of the cooling throttle based upon at least one of the outputs of the pressure sensor, the first temperature sensor, and the second temperature sensor.

According to one process, a method of controlling cooling flow through a coolant system of an internal combustion engine having an electronic control module, a cooling throttle, an EGR cooler, and an interstage cooler is provided. A pressure within a coolant system is determined. A temperature within the coolant system is determined A temperature of exhaust gas exiting an EGR cooler is determined. A temperature of intake air exiting an interstage cooler is determined. A position of a cooling throttle within the coolant system is adjusted based upon at least one of the determined pressure within the coolant system, temperature within the coolant system, temperature of exhaust gas exiting the EGR cooler, and temperature of intake air exiting an interstage cooler being above respective predefined thresholds to adjust fluid flow within the coolant system.

According to another process, a method of controlling cooling flow through a coolant system of an internal combustion engine having an electronic control module, a cooling throttle, an EGR cooler, and an interstage cooler is provided. A pressure within a coolant system is determined. The pressure within the coolant system is compared to a predefined coolant system pressure threshold stored within an electronic control module. A temperature within the coolant system is determined The temperature within the coolant system is compared to a predefined coolant temperature threshold stored within the electronic control module. A temperature of exhaust gas exiting an EGR cooler is determined. The temperature of the exhaust gas exiting the EGR cooler is compared to a predefined exhaust gas temperature threshold stored within the electronic control module. A position of a cooling throttle within the coolant system is adjusted if at least one of the pressure within the coolant system exceeds the predefined coolant system pressure threshold, the temperature within the coolant system exceeds the predefined coolant temperature threshold, and the temperature of the exhaust gas exiting the EGR cooler exceeds the predefined exhaust gas temperature threshold.

### BRIEF DESCRIPTION OF THE DRAWINGS

FIG. 1 is a schematic diagram showing a portion of an engine cooling system for an engine having a coolant throttle to control cooling flow through the cooling system.

FIG. 2 is a flow chart showing one method of controlling a position of a coolant throttle.

### DETAILED DESCRIPTION

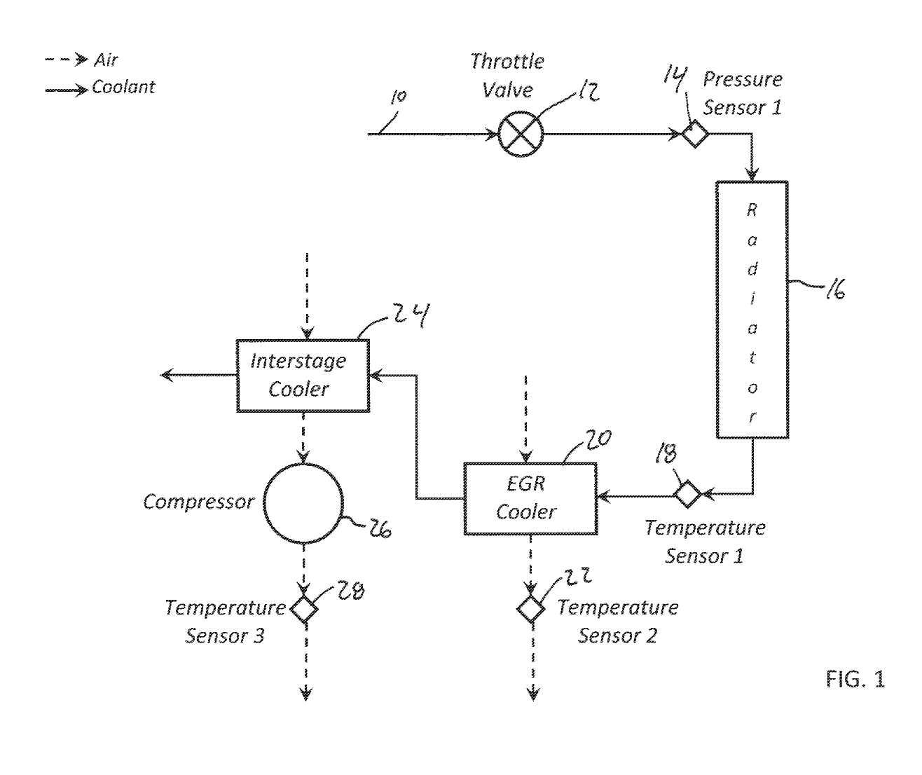

FIG. 1 shows a portion of a cooling system 10 for an internal combustion engine, the cooling system 10 having a cooling throttle 12. The cooling throttle 12 is positionable between an open position and a closed position to regulate a flow rate of coolant within the cooling system 10. It is contemplated that the cooling throttle may be positioned at a variety of positions between the open position and the closed position to regulate the flow arte of the cooling system 10. The position of the cooling throttle 12 is controlled by an electronic control module (ECM). The cooling system 10 additionally comprises a pressure sensor 14. The pressure sensor 14 is located near an inlet of a radiator 16 and is disposed in fluid communication with the cooling system 10. The pressure sensor 14 generates an output indicative of the pressure within the cooling system 10. The pressure sensor 14 is also disposed in communication with the ECM. The output of the pressure sensor 14 is utilized by the ECM to determine if the pressure within the cooling system 10 is above a predefined pressure limit. If the output of the pressure sensor 14 indicates that coolant within the cooling system 10 is above the predefined pressure limit, the cooling throttle 12 may be closed to reduce a coolant flow rate, and thereby reduce the pressure of the coolant within the cooling system 10.

A first temperature sensor 18 is disposed in fluid communication with the cooling system 10 downstream of the radiator 16. The radiator 16 is adapted to be positioned within an air flow when the vehicle is moving, and may additionally have a fan near the radiator 16 to pull air through the radiator, in order to transfer heat from the coolant within the cooling system 10, to the air passing through the radiator. The first temperature sensor 18 generates an output indicative of the temperature of the coolant within the cooling system 10 after it has been cooled by the radiator 16. The first temperature sensor 18 is also disposed in communication with the ECM. The output of the first temperature sensor 18 is utilized by the ECM to determine if the radiator 16 is reducing the temperature of the coolant to a predefined range of operating temperatures. If the output of the first temperature sensor 18 indicates that coolant within the cooling system 10 that has passed through the radiator 16 is above a predefined temperature, the cooling throttle 12 may be opened to increase a coolant flow rate, and thereby reduce the temperature of the coolant flowing past the first temperature sensor 18.

The cooling system 10 additionally comprises an EGR cooler 20. The EGR cooler 20 receives coolant within the cooling system to reduce the temperature of exhaust gas passing through the EGR cooler 20, before that exhaust gas is fed into the air intake system of the engine to be mixed with fresh air and used for combustion. The EGR cooler 20 reduces the temperature of the exhaust gas to a level that allows the engine to function as intended. A second temperature sensor 22 is disposed in fluid communication with the exhaust gas passing through the EGR cooler. The second temperature sensor 22 is disposed downstream of the EGR cooler 20. The second temperature sensor 22 therefore may be used to determine if the exhaust gas is being cooled sufficiently by the EGR cooler 20, or if additional coolant flow is required through the EGR cooler 20. The second temperature sensor 22 is disposed in communication with the ECM. The output of the second temperature sensor 22 is utilized by the ECM to determine if the EGR cooler 20 is reducing the temperature of the exhaust gas to a predefined range of operating temperatures. If the output of the second temperature sensor 22 indicates that exhaust gas that has passed through the EGR cooler 20 is above a predefined temperature, the cooling throttle 12 may be opened to increase a coolant flow rate, and thereby reduce the temperature of the coolant flowing into the EGR cooler 20, thereby reducing the temperature of the exhaust gas flowing past the second temperature sensor 22.

The cooling system 10 further comprises an interstage cooler 24. The interstage cooler 24 receives coolant within the cooling system 10 to reduce the temperature of intake air passing through the interstage cooler 24, before that intake air enters into a compressor 26 of a turbocharger in an air intake system of the engine. The interstage cooler 24 reduces the temperature of the intake to a level that allows the engine to function as intended. A third temperature sensor 28 is disposed in fluid communication with the intake air passing through the interstage cooler 24 and the compressor 26. The third temperature sensor 28 is disposed downstream of the interstage cooler 24. The third temperature sensor 24 therefore may be used to determine if the intake air is being cooled sufficiently by the interstage cooler 24, or if additional coolant flow is required through the interstage cooler 24. The third temperature sensor 28 is disposed in communication with the ECM. The output of the third temperature sensor 28 is utilized by the ECM to determine if the interstage cooler 24 is reducing the temperature of the exhaust gas to a predefined range of operating temperatures. If the output of the third temperature sensor 28 indicates that intake air that has passed through the interstage cooler 24 is above a predefined temperature, the cooling throttle 12 may be opened to increase a coolant flow rate, and thereby reduce the temperature of the coolant flowing into the interstage cooler 24, thereby reducing the temperature of the intake air flowing past the third temperature sensor 28.

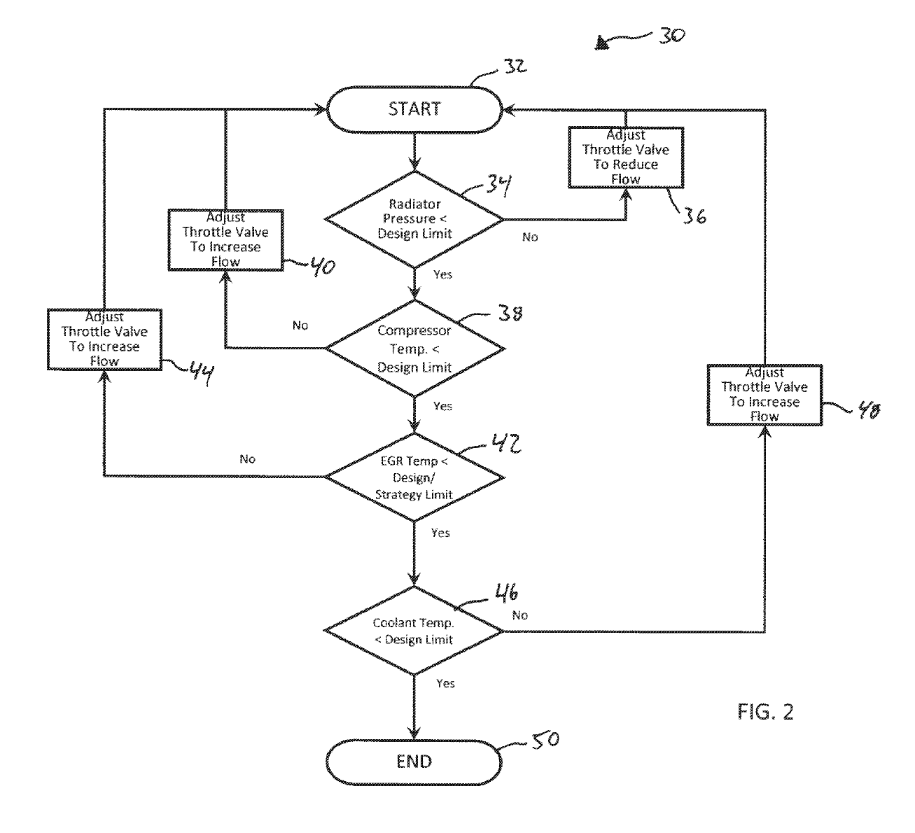

Turning now to FIG. 2, a flow chart is shown depicting one process 30 of controlling the position of the cooling throttle 12. The process 30 of controlling the position of the cooling throttle 12 is initiated as shown at block 32. An output of the pressure sensor 14 of the cooling system 10 is compared to a predefined pressure limit value stored in the ECM at block 34. If the pressure within the cooling system 10 is above the predefined pressure limit, the cooling throttle 12 is moved to a more closed position to reduce the flow of coolant within the cooling system 10, and, consequently, reduce the pressure within the cooling system 10 as shown at block 36.

If the pressure is not above the predefined pressure limit, the method 30 determines if the temperature of intake air exiting a compressor 26 of a turbocharger is above a first predefined temperature limit, as shown at block 38. If the temperature of intake air exiting a compressor 26 of the turbocharger is above the first predefined temperature, the cooling throttle 12 is moved to a more open position to increase the flow of coolant through the cooling system 10 as shown at block 40.

If the temperature of intake air exiting a compressor 26 is not above the first predefined temperature, a temperature of exhaust gas exiting an EGR cooler 20 is compared to a second predefined temperature, as shown at block 42. If the temperature of exhaust gas exiting the EGR cooler 20 is above the second predefined temperature, the cooling throttle 12 is moved to a more open position, to increase the flow of coolant through the cooling system 10, as shown at block 44.

If the temperature of exhaust gas exiting the EGR cooler 20 is not above the second predefined temperature, a temperature of coolant within the cooling system 10 is compared to a third predefined temperature, as shown at block 46. If the temperature of coolant within the cooling system 10 is above the third predefined temperature, the cooling throttle 12 is moved to a more open position, to increase the flow of coolant through the cooling system 10, as shown at block 48. If the temperature of the coolant is not above the third predefined temperature, the method ends, as shown at block 50, and will be restarted at block 32 after a predefined period of time.

The method 30 therefore protects the cooling system 10 from operating at a pressure that is above the predefined pressure limit of the cooling system 10, while also ensuring that if the pressure is not above the predefined pressure limit, the temperature of coolant within the cooling system 10, the temperature of exhaust gas exiting the EGR cooler 20, and the temperature of intake air exiting a compressor 26 of the turbocharger may be controlled by adjusting coolant flow through a coolant throttle 12 to a more open position. If the pressure of the coolant system 10 is above the predefined pressure limit, and at least one of the temperature sensors indicates a temperature above a predefined limit, engine performance may be limited to prevent damage to the engine, or the cooling system 10 of the engine.

What is claimed is:

1. An engine cooling system for an internal combustion engine comprising:
an electronic control module;
a cooling throttle being positionable between an open position and a closed position, the cooling throttle being disposed in fluid communication with the cooling system and in communication with the electronic control module, the cooling throttle being provided for controlling a flow rate of coolant within the cooling system;
a pressure sensor being disposed in fluid communication with the cooling system, the pressure sensor disposed in communication with the electronic control module, the pressure sensor including logic generating an output to the electronic control module;
a first temperature sensor being disposed in fluid communication with the cooling system, the first temperature sensor disposed in communication with the electronic control module and including logic for generating an output to the electronic control module; and
a second temperature sensor being disposed in fluid communication with exhaust gas downstream of an EGR cooler, the second temperature sensor disposed in communication with the electronic control module and including logic for generating an output to the electronic control module, wherein the electronic control module generates an output to adjust the position of the cooling throttle based upon at least one of the outputs of the pressure sensor, the first temperature sensor, and the second temperature sensor.

2. The engine cooling system for an internal combustion engine of claim 1, further comprising a third temperature sensor being disposed in fluid communication with intake air downstream of a compressor, the third temperature sensor disposed in communication with the electronic control module and including logic for generating an output to the electronic control module.

3. The engine cooling system for an internal combustion engine of claim 1, wherein the electronic control module comprises a processor and a memory, the memory of the electronic control module storing a predefined pressure threshold, a predefined cooling system temperature threshold, and a predefined exhaust gas temperature threshold.

4. The engine cooling system for an internal combustion engine of claim 3, wherein the cooling throttle is positioned towards a closed position when the output of the pressure sensor is above the predefined pressure threshold.

5. The engine cooling system for an internal combustion engine of claim 3, wherein the cooling throttle is positioned towards an open position when the output of the first temperature sensor is above the predefined coolant system temperature threshold.

6. The engine cooling system for an internal combustion engine of claim 3, wherein the cooling throttle is positioned towards an open position when the output of the second temperature sensor is above the predefined exhaust gas temperature threshold.

7. The engine cooling system of claim 3, wherein the cooling throttle is positioned towards a closed position when the output of the pressure sensor exceeds the predefined pressure threshold, and at least one of the output of the first temperature sensor exceeds the predefined coolant system temperature threshold and the output of the second temperature sensor exceeds the predefined exhaust gas temperature threshold.

8. The engine cooling system of claim 3, wherein the cooling throttle is positioned based upon the output of the one of the output of the first temperature sensor and the output of the second temperature sensor that most exceeds the respective temperature thresholds.

9. A method of controlling cooling flow through a coolant system of an internal combustion engine having an electronic control module, a cooling throttle, an EGR cooler, and an interstage cooler, the method comprising:
determining a pressure within a coolant system;
determining a temperature within the coolant system;
determining a temperature of exhaust gas exiting an EGR cooler;
determining a temperature of intake air exiting an interstage cooler; and
adjusting a position of a cooling throttle within the coolant system based upon at least one of the determined pressure within the coolant system, temperature within the coolant system, temperature of exhaust gas exiting the EGR cooler, and temperature of intake air exiting an interstage cooler being above respective predefined thresholds to adjust fluid flow within the coolant system.

10. The method of claim 9, further comprising comparing the determined pressure within the coolant system with a predefined pressure threshold stored in a memory of an electronic control module.

11. The method of claim 9, further comprising comparing the determined temperature within the coolant system with a predefined coolant temperature threshold stored in a memory of an electronic control module.

12. The method of claim 9, further comprising comparing the determined temperature of exhaust gas exiting the EGR cooler with a predefined exhaust gas temperature threshold stored in a memory of an electronic control module.

13. The method of claim 9, further comprising comparing the determined temperature of intake exiting an interstage cooler with a predefined exhaust gas temperature threshold stored in a memory of an electronic control module.

14. The method of claim 9, wherein the determined pressure within the cooling system exceeding the predefined threshold adjusts the cooling throttle towards a closed position.

15. The method of claim 14, wherein the determined temperature within the cooling system exceeding the predefined threshold adjusts the cooling throttle towards an open position.

16. The method of claim 14, wherein the determined temperature of exhaust gas exiting the EGR cooler exceeding the predefined threshold adjusts the cooling throttle towards an open position.

17. The method of claim 14, wherein the determined temperature of intake air exiting the interstage cooler exceeding the predefined threshold adjusts the cooling throttle towards an open position.

18. A method of controlling cooling flow through a coolant system of an internal combustion engine having an electronic control module, a cooling throttle, an EGR cooler, and an interstage cooler, the method comprising:
determining a pressure within a coolant system;
comparing the pressure within the coolant system to a predefined coolant system pressure threshold stored within an electronic control module;
determining a temperature within the coolant system;
comparing the temperature within the coolant system to a predefined coolant temperature threshold stored within the electronic control module;
determining a temperature of exhaust gas exiting an EGR cooler;
comparing the temperature of the exhaust gas exiting the EGR cooler to a predefined exhaust gas temperature threshold stored within the electronic control module; and
adjusting a position of a cooling throttle within the coolant system if at least one of the pressure within the coolant system exceeds the predefined coolant system pressure threshold, the temperature within the coolant system exceeds the predefined coolant temperature threshold, and the temperature of the exhaust gas exiting the EGR cooler exceeds the predefined exhaust gas temperature threshold.

19. The method of claim 18, wherein the adjusting the position of the cooling throttle based upon the pressure within the coolant system exceeding the predefined coolant pressure threshold prevents adjusting the position of the cooling throttle based upon the temperature within the coolant system exceeding the predefined coolant temperature threshold.

20. The method of claim 18, wherein the adjusting the position of the cooling throttle based upon the pressure within the coolant system exceeding the predefined coolant pressure threshold prevents adjusting the position of the cooling throttle based upon the temperature of exhaust gas exiting the EGR cooler exceeding the predefined exhaust gas temperature threshold.
